(19) United States
(12) Patent Application Publication
(10) Pub. No.: US 2024/0024816 A1
(43) Pub. Date: Jan. 25, 2024

(54) EXHAUST GAS PURIFICATION CATALYST

(71) Applicants: TOYOTA JIDOSHA KABUSHIKI KAISHA, Toyota-shi (JP); CATALER CORPORATION, Kakegawa-shi (JP)

(72) Inventors: Toshimasa Hara, Nisshin-shi (JP); Motohisa Kado, Gotemba-shi (JP); Taizo Yoshinaga, Numazu-shi (JP); Hirohito Hirata, Nagaizumi-cho (JP); Takahiro Suzuki, Kikugawa-shi (JP); Shunsuke Oishi, Kakegawa-shi (JP); Kazuyoshi Tsukamoto, Mori-machi (JP); Fumiyasu Oba, Tokyo-to (JP)

(21) Appl. No.: 18/353,955

(22) Filed: Jul. 18, 2023

(30) Foreign Application Priority Data
Jul. 19, 2022 (JP) 2022-114885
Mar. 30, 2023 (JP) 2023-055201

(51) Int. Cl. B01D 53/86; B01J 23/46; B01J 23/20; B01J 21/06; B01J 35/00; B01J 37/02; B01J 37/03

(52) U.S. Cl. CPC B01D 53/8628; B01J 23/464; B01J 23/20; B01J 21/063; B01J 35/0013; B01J 37/0215; B01J 37/036; B01D 2255/1025; B01D 2255/207

(57) ABSTRACT

The present disclosure provides an exhaust gas purification catalyst with increased catalytic activity. The exhaust gas purification catalyst comprises a metal oxide support and Rh particles supported on the metal oxide support, wherein the metal oxide support is doped with a cation having a higher oxidation number than the cation of the metal oxide support. The metal oxide support may be a SrTiO₃ support doped with greater than 0 mol % and 8 mol % or lower Nb, a ZrO₂ support doped with 5 mol % to 20 mol % Nb, or an Al₂O₃ support doped with greater than 0 mol % and 7 mol % or lower Ti.

### FIELD

The present disclosure relates to an exhaust gas purification catalyst.

### BACKGROUND

PTL 1 discloses an exhaust gas purification catalyst that includes: a precious metal; alumina support particles; and ZrO₂ semiconductor particles supported on the surfaces of the alumina support particles.

### CITATION LIST

### Patent Literature

[PTL 1] International Patent Publication No. WO2020/050464

### SUMMARY

### Technical Problem

There is a need for increased catalytic activity for exhaust gas purifying catalysts, and particularly three-way catalysts.

It is an object of the present disclosure to provide an exhaust gas purification catalyst with increased catalytic activity.

### Solution to Problem

The present inventors have found that the aforementioned object can be achieved by the following means:

### <Aspect 1>

An exhaust gas purification catalyst
comprising a metal oxide support and Rh particles supported on the metal oxide support,
wherein the metal oxide support is doped with a cation having a higher oxidation number than the cation of the metal oxide support.

### <Aspect 2>

The exhaust gas purification catalyst according to aspect 1, wherein the metal oxide support is a SrTiO₃ support doped with greater than 0 mol % and 8 mol % or lower Nb, a ZrO₂ support doped with 5 mol % to 20 mol % Nb, or an Al₂O₃ support doped with greater than 0 mol % and 7 mol % or lower Ti.

### <Aspect 3>

The exhaust gas purification catalyst according to aspect 1, wherein the metal oxide support is a SrTiO₃ support doped with greater than 0 mol % and 8 mol % or lower Nb, and has a peak from SrTiO₃ of the SrTiO₃ support in the range of 32.20°<2θ<32.38°, in the X-ray diffraction spectrum by X-ray crystal diffraction using CuKα rays.

### <Aspect 4>

The exhaust gas purification catalyst according to aspect 1, wherein the metal oxide support is a SrTiO₃ support doped with greater than 0 mol % and 8 mol % or lower Nb, and the near-infrared diffuse reflectance spectrum of the SrTiO₃ support at a wavelength of 900 nm or greater is larger than the near-infrared diffuse reflectance spectrum of a non-Nb-doped SrTiO₃ support at a wavelength of 900 nm or greater.

### <Aspect 5>

The exhaust gas purification catalyst according to aspect 1, wherein the metal oxide support is a SrTiO₃ support doped with greater than 0 mol % and 8 mol % or lower Nb, and the peak for the bond energy of the 3d orbital of Rh is in the range of 306 to 307 eV after hydrogen reduction in a 1% H₂/N₂ atmosphere with a heating temperature of 400° C. and a heating time of 1 hour.

### <Aspect 6>

The exhaust gas purification catalyst according to any one of aspects 1 to 5, which is a three-way catalyst.

### <Aspect 7>

An exhaust gas purification method which includes contacting exhaust gas with an exhaust gas purification catalyst according to any one of aspects 1 to 5.

### <Aspect 8>

A method for producing an exhaust gas purification catalyst according to any one of aspects 1 to 5, wherein the method includes:
providing the metal oxide support, and
loading Rh particles onto the metal oxide support.

### <Aspect 9>

The method according to aspect 8, wherein the metal oxide support is a SrTiO₃ support doped with greater than 0 mol % and 8 mol % or lower Nb.

### <Aspect 10>

The method according to aspect 8, wherein the metal oxide support is a ZrO₂ support doped with 5 mol % to 20 mol % Nb.

### <Aspect 11>

The method according to aspect 8, wherein the metal oxide support is an Al₂O₃ support doped with greater than 0 mol % and 7 mol % or lower Ti.

### <Aspect 12>

The method according to aspect 9, wherein provision of the SrTiO₃ support includes synthesizing the SrTiO₃ support by a sol-gel method.

### <Aspect 13>

The method according to aspect 10, wherein provision of the ZrO₂ support includes synthesizing the ZrO₂ support by a citric acid method.

### <Aspect 14>

The method according to aspect 11, wherein provision of the Al₂O₃ support includes synthesizing the Al₂O₃ support by complex polymerization.

### Advantageous Effects of Invention

According to the present disclosure it is possible to provide an exhaust gas purification catalyst with increased catalytic activity.

### BRIEF DESCRIPTION OF DRAWINGS

FIG. 1 is a schematic diagram showing a state of the exhaust gas purification catalyst 1 of the disclosure while purifying exhaust gas.

FIG. 2 is a graph showing an electron orbital image during Rh—O bonding.

FIG. 3 is a graph showing an electron orbital image during Rh—O bonding, where Rh is in an electron-enriched state.

FIG. 4 is a diagram showing the energy state without a junction between a metal and an n-type semiconductor.

FIG. 5 is a diagram showing the energy state with a Schottky junction between a metal and an n-type semiconductor.

FIG. 6 is a graph showing X-ray diffraction spectra for different samples.

FIG. 7 is a graph showing X-ray diffraction spectra for different samples.

FIG. 8 is a graph showing UV-vis-NIR diffuse reflectance spectra for different samples.

FIG. 9 is a graph showing measurement results for X-ray photoelectron spectroscopy of the samples of Example 1-1 and Comparative Examples 1-1 and 1-2.

FIG. 10 is a graph showing the relationship between time and temperature under catalytic activity evaluation conditions for different samples.

FIG. 11 is a graph showing catalytic activity evaluation results for the samples of Examples 1-1 and 1-2, and Comparative Example 1-1.

FIG. 12 is a graph showing catalytic activity evaluation results for the samples of Examples 1-1 and 1-2, and Comparative Examples 1-1 and 1-2.

FIG. 13 is a graph showing X-ray diffraction spectra for the sample of Comparative Example 2-1.

FIG. 14 is a graph showing X-ray diffraction spectra for the samples of Examples 2-1 to 2-4 and Comparative Examples 2-2 and 2-3.

FIG. 15 is a magnified view of the region of 2θ=29.8 to 30.6 in the X-ray diffraction spectra for the samples of Examples 2-2 to 2-4.

FIG. 16 is a graph showing measurement results for X-ray photoelectron spectroscopy of the samples of Examples 2-1 to 2-3 and Comparative Example 2-1.

FIG. 17 is a graph showing catalytic activity evaluation results for the samples of Examples 2-1, 2-3 and 2-4 and Comparative Examples 2-1 and 2-3.

FIG. 18 is a graph showing catalytic activity evaluation results for the samples of Examples 2-1, 2-3 and 2-4 and Comparative Example 2-1 and 2-3.

FIG. 19 is a graph showing X-ray diffraction spectra for the samples of Examples 3-1 to 3-4 and Comparative Examples 3-1 and 3-2.

FIG. 20 is a graph comparing the main peak locations in X-ray diffraction spectra for the samples of Examples 3-1 to 3-4 and Comparative Examples 3-1 and 3-2.

FIG. 21 is a graph showing measurement results for X-ray photoelectron spectroscopy of samples for Example 3-3 and Comparative Examples 3-1 and 3-2.

FIG. 22 is a graph showing catalytic activity evaluation results for the samples of Examples 3-1 to 3-4 and Comparative Examples 3-1 and 3-2.

FIG. 23 is a graph showing catalytic activity evaluation results for the samples of Examples 3-1 to 3-4 and Comparative Examples 3-1 and 3-2.

### DESCRIPTION OF EMBODIMENTS

Embodiments of the disclosure will now be described in detail. However, the disclosure is not limited to the embodiments described below, and various modifications may be implemented which do not depart from the gist thereof.

### <Exhaust Gas Purification Catalyst>

The exhaust gas purification catalyst of the disclosure is an exhaust gas purification catalyst comprising a metal oxide support and Rh particles supported on the metal oxide support, wherein the metal oxide support is doped with a cation having a higher oxidation number than the cation of the metal oxide support.

The metal oxide support may be a SrTiO₃ support doped with greater than 0 mol % and 8 mol % or lower Nb, a ZrO₂ support doped with 5 mol % to 20 mol % Nb, or an Al₂O₃ support doped with greater than 0 mol % and 7 mol % or lower Ti.

Rh used as a catalyst metal generally exhibits high catalytic activity especially for NOx reduction, in comparison to Pd or Pt. Increasing the catalytic activity of Rh allows a lower amount of Rh to be used.

The rate-determining step for reduction of NOx in exhaust gas is in the CO₂ generation pathway. Specifically, the rate-determining step is reaction between CO and O atoms adsorbed onto Rh. Thus, lowering the adsorption energy of O atoms adsorbed onto Rh can improve the NOx reduction performance of the exhaust gas purification catalyst.

The exhaust gas purification catalyst of the disclosure, being an exhaust gas purification catalyst having Rh particles supported on a metal oxide support, has the metal oxide support electron-enriched by doping the metal oxide support with a cation having a higher oxidation number than the cation of the metal oxide support. The electrons flow into the Rh, lowering the adsorption energy of O atoms.

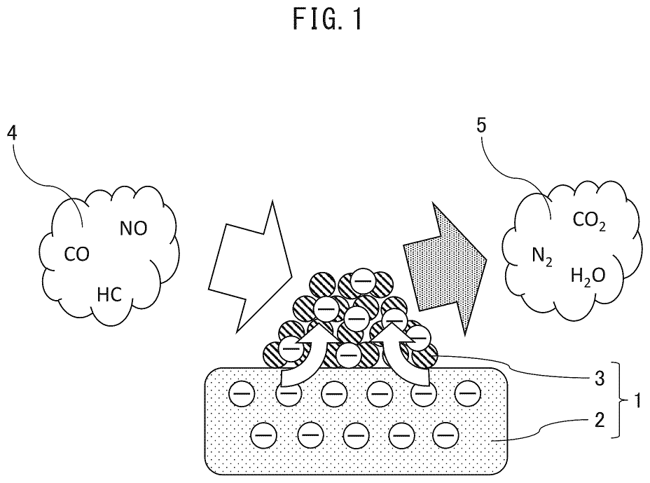

An example where the metal oxide support is a SrTiO₃ support will now be explained in detail with reference to FIGS. 1 to 3.

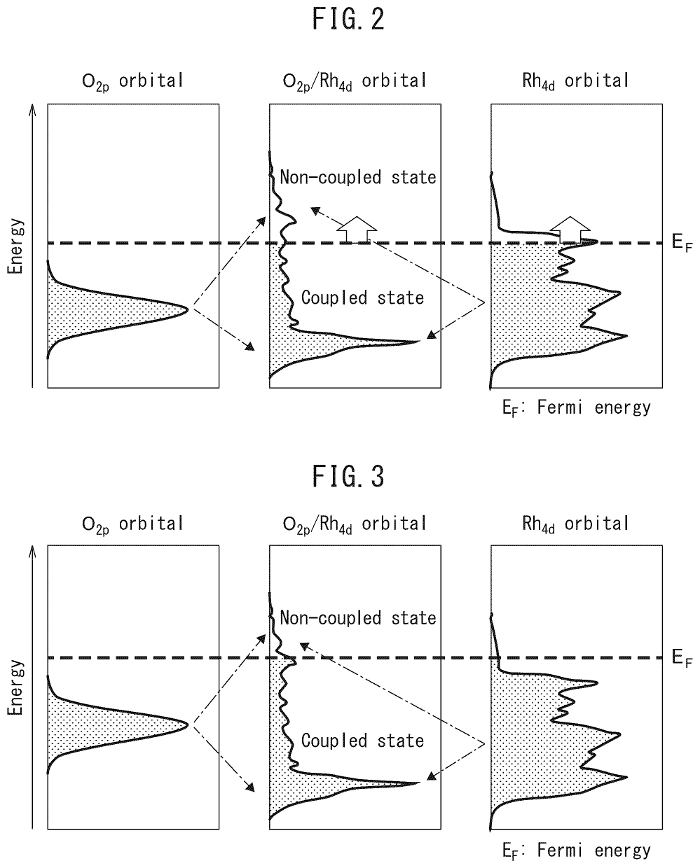

FIG. 1 is a schematic diagram showing a state of the exhaust gas purification catalyst 1 of the disclosure while purifying exhaust gas. FIG. 2 is a graph showing an electron orbital image during Rh—O bonding, and FIG. 3 is a graph showing an electron orbital image during Rh—O bonding, where Rh is in an electron-enriched state.

As shown in FIG. 1, the exhaust gas purification catalyst 1 of the disclosure comprises a SrTiO₃ support 2 doped with greater than 0 mol % and 8 mol % or lower Nb, and Rh particles 3 supported on the SrTiO₃ support. Since the SrTiO₃ support 2 in the exhaust gas purification catalyst 1 of the disclosure is doped with Nb, it has more free electrons than a non-Nb-doped SrTiO₃ support. The electrons in the Nb-doped SrTiO₃ support 2 flow into the Rh particles 3.

When the electrons are not flowing into the Rh particles, the energies of the O₂ₚ orbital, O₂ₚ/Rh_{4d} orbital and Rh_{4d} orbital are as shown in FIG. 2. In this state, there are fewer electrons in an antibonding orbital (antibonding state) for the O₂ₚ/Rh_{4d} orbital. However, when Rh is in an electron-enriched state (that is, electrons have flowed into the Rh particles), as shown in FIG. 3, this increases the proportion of electrons in an antibonding orbital (antibonding state) during O-bonding. The Rh—O bonding strength is thereby reduced, lowering the adsorption energy of the O atoms.

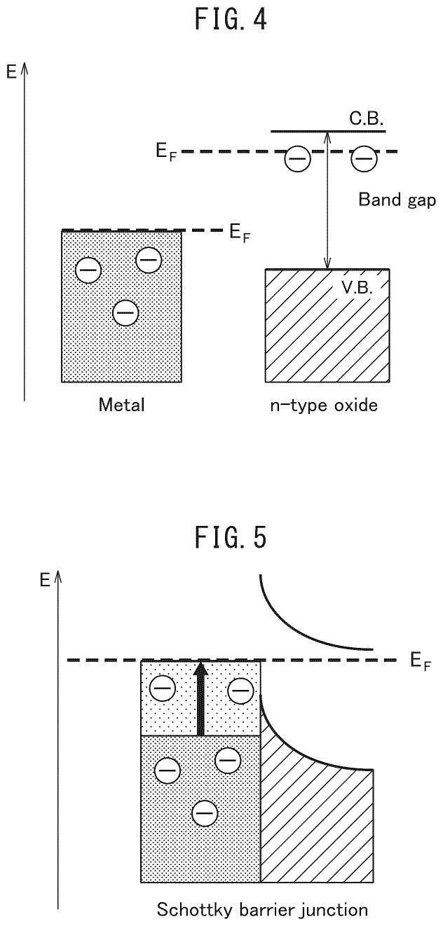

When a metal (such as Rh) is contacted with an n-type semiconductor (oxide support), as shown in FIGS. 4 and 5, electrons flow into the metal from the n-type semiconductor until the Fermi levels match each other, so that the metal becomes electron-enriched.

The exhaust gas purification catalyst of the disclosure may also be a three-way catalyst.

The exhaust gas purification catalyst of the disclosure may also be used in a manner disposed on a base material, and more specifically a honeycomb substrate, for example.

### <Metal Oxide Support>

The metal oxide support of the exhaust gas purification catalyst of the disclosure is doped with a cation having a higher oxidation number than the cation of the metal oxide support. The metal oxide support doped with a cation may be a SrTiO₃ support doped with Nb, a ZrO₂ support doped with Nb, or an Al₂O₃ support doped with Ti.

When the metal oxide support is a SrTiO₃ support doped with Nb, the SrTiO₃ support may be doped with greater than 0 mol % and 8 mol % or lower Nb.

The SrTiO₃ support may be doped with Nb at greater than 0 mol %, 1 mol % or greater, 2 mol % or greater or 3 mol % or greater, and 8 mol % or lower, 7 mol % or lower, 6 mol % or lower or 5 mol % or lower.

That the SrTiO₃ support is “doped with greater than 0 mol % and 8 mol % or lower Nb” means that the amount of Nb atoms is greater than 0 mol % and 8 mol % or lower, where 100 mol % is the total of Ti atoms and Nb atoms in the SrTiO₃ support.

The SrTiO₃ support doped with Nb may have a peak from SrTiO₃ of the SrTiO₃ support in the range of 32.20°<2θ<32.38°, in the X-ray diffraction spectrum by X-ray crystal diffraction using CuKα rays.

Since the SrTiO₃ support in the exhaust gas purification catalyst of the disclosure has the Ti sites replaced with Nb, the diffraction peak in the X-ray crystal diffraction spectrum may be shifted toward the low angle end due to expansion of the crystal lattice.

The near-infrared diffuse reflectance spectrum of the SrTiO₃ support at a wavelength of 900 nm or greater in the SrTiO₃ support doped with Nb is larger than the near-infrared diffuse reflectance spectrum of a non-Nb-doped SrTiO₃ support at a wavelength of 900 nm or greater. Nb doping, which increases the density of free electrons (carriers) in SrTiO₃ causes absorption by surface plasmon resonance to also increase. The near-infrared diffuse reflectance spectrum is the diffuse reflectance spectrum in the near-infrared region (the region of electromagnetic radiation with a wavelength of 800 to 2500 nm).

When the metal oxide support used is a ZrO₂ support doped with Nb, the ZrO₂ support may be doped with 5 mol % to 20 mol % Nb.

The ZrO₂ support may be doped with Nb at greater than 5 mol % or greater, 7 mol % or greater, 10 mol % or greater or 15 mol % or greater, and 20 mol % or lower, 18 mol % or lower, 15 mol % or lower or 10 mol % or lower.

That the ZrO₂ support is “doped with 5 mol % to 20 mol % Nb” means that the amount of Nb atoms is 5 mol % to 20 mol %, where 100 mol % is the total of Zr atoms and Nb atoms in the ZrO₂ support.

The ZrO₂ support doped with Nb may have a peak from ZrO₂ of the ZrO₂ support in the range of 29.800<2θ<30.60°, in the X-ray diffraction spectrum by X-ray crystal diffraction using CuKα rays.

Since the SrTiO₃ support in the exhaust gas purification catalyst of the disclosure has the Ti sites replaced with Nb, the diffraction peak in the X-ray crystal diffraction spectrum may be shifted toward the low angle end due to expansion of the crystal lattice.

The ZrO₂ support doped with Nb may be tetragonal.

When the metal oxide support used is an Al₂O₃ support doped with Ti, the Al₂O₃ support may be doped with greater than 0 mol % and 7 mol % or lower Ti.

The Al₂O₃ support may be doped with Ti at greater than 0 mol %, 1 mol % or greater, 3 mol % or greater or 5 mol % or greater, and 7 mol % or lower, 6 mol % or lower, 5 mol % or lower or 4 mol % or lower.

That the Al₂O₃ support is “doped with greater than 0 mol % and 7 mol % or lower Ti” means that the amount of Ti atoms is greater than 0 mol % and 7 mol % or lower, where 100 mol % is the total of Al atoms and Ti atoms in the Al₂O₃ support.

The Al₂O₃ support doped with Ti may have a peak from Al₂O₃ in the range of 67.100<2θ<66.85°, in the X-ray diffraction spectrum by X-ray crystal diffraction using CuKα rays.

Since the SrTiO₃ support in the exhaust gas purification catalyst of the disclosure has the Ti sites replaced with Nb, the diffraction peak in the X-ray crystal diffraction spectrum may be shifted toward the low angle end due to expansion of the crystal lattice.

The ZrO₂ support doped with Nb may be tetragonal.

### <Rh Particles>

The Rh particles in the exhaust gas purification catalyst of the disclosure are supported on a metal oxide support.

The sizes and shapes of the Rh particles may be any sizes and shapes used for catalyst metals in exhaust gas purification catalysts.

More specifically, the Rh particles may have a median diameter (D50) of 0.1 to 10.0 nm. The median diameter (D50) of the Rh particles may be 0.1 nm or larger, 1.0 nm or larger, 2.0 nm or larger or 2.5 nm or larger, and 10.0 nm or smaller, 5.0 nm or smaller, 3.0 nm or smaller or 2.5 nm or smaller.

The median diameter (D50) can be measured by particle size distribution measurement using a laser diffraction particle size distribution meter (SALD-2300) by Shimadzu Corp., determining the particle size at 50% cumulative frequency.

The loading mass of the Rh particles on the metal oxide support may be 0.1 to 5.0 mass % with respect to the total exhaust gas purification catalyst, for example. The loading mass of the Rh particles on the metal oxide support may be 0.1 mass % or greater, 0.2 mass % or greater, 0.3 mass % or greater or 0.4 mass % or greater, and 5.0 mass % or lower, 2.5 mass % or lower, 1.0 mass % or lower or 0.5 mass % or lower.

When the metal oxide support is a SrTiO₃ support doped with Nb, the peak for the bond energy of the 3d orbital of Rh for the Rh particles may be in the range of 306 to 307 eV after hydrogen reduction in a 1% H₂/N₂ atmosphere with a heating temperature of 400° C. and a heating time of 1 hour. Such a bond energy peak is shifted toward the low energy end compared to the peak for the bond energy of the 3d orbital of Rh supported on a normal SrTiO₃ support, i.e. one that is not doped with Nb. This indicates that electrons have migrated from the SrTiO₃ support doped with Nb to the Rh particles. The bond energy peak can be measured by an X-ray photoelectron spectroscopy test.

### <Exhaust Gas Purification Method>

The exhaust gas purification method of the disclosure includes contacting exhaust gas with an exhaust gas purification catalyst of the disclosure. However, the method for contacting the exhaust gas with the exhaust gas purification catalyst is not particularly restricted.

The exhaust gas may comprise NOx, CO and HC, for example.

### <Method for Producing Exhaust Gas Purification Catalyst>

The production method of the disclosure is a method for producing the exhaust gas purification catalyst of the disclosure. The production method of the disclosure includes providing a metal oxide support and supporting Rh particles on the metal oxide support. The metal oxide support is doped with a cation having a higher oxidation number than the cation of the metal oxide support.

The metal oxide support may be a SrTiO₃ support doped with greater than 0 mol % and 8 mol % or lower Nb, a ZrO₂ support doped with 5 mol % to 20 mol % Nb, or an Al₂O₃ support doped with greater than 0 mol % and 7 mol % or lower Ti.

Providing a metal oxide support may include any method which allows some of the cations forming the crystal lattice of the metal oxide support to be replaced with cations having a higher oxidation number than the cations.

When a SrTiO₃ support doped with Nb is used as the metal oxide support, the method of the disclosure may include synthesizing the SrTiO₃ support by a sol-gel method. When a ZrO₂ support doped with Nb is used as the metal oxide support, the method of the disclosure may include synthesizing the ZrO₂ support by a citric acid method. When an Al₂O₃ support doped with Ti is used as the metal oxide support, the method of the disclosure may include synthesizing the Al₂O₃ support by complex polymerization.

The method of supporting the Rh particles on the SrTiO₃ support may employ any method that allows a catalyst metal to be supported on a catalyst support.

### EXAMPLES

### Examples 1-1 and 1-2 and Comparative Examples 1-1 to 1-3

### Example 1-1

### (Synthesis of Rh Nanoparticles)

After adding 0.972 mmol of a rhodium chloride solution to a flask and evaporating off the moisture to dryness, 1.29 g of polyvinylpyrrolidone (PVP) and 270 g of ethylene glycol (EG) were added and the mixture was stirred at room temperature to dissolve the rhodium chloride and PVP in the EG. To this solution there was added 200 μL of a 15.6 mol/L concentration sodium hydroxide solution, and the mixture was stirred for 24 hours at 120° C. under a nitrogen atmosphere. After cooling the solution to room temperature, a mixed solvent of acetone and hexane was added, the mixture was centrifuged, and the precipitate was re-dispersed in ethanol to obtain Rh nanoparticles.

### (Synthesis of Nb-Doped SrTiO₃)

Nb-doped SrTiO₃ was synthesized by a sol-gel method. Specifically, distilled water, citric acid, strontium nitrate, a titanium(IV) dihydroxybis(ammonium lactate) solution and niobium ammonium oxalate hydrate were mixed in a beaker, and the mixture was heated and stirred and evaporated to dryness. The mixture was then further dried overnight in a constant temperature furnace at 120° C. The dried product was fired in air at 850° C. for 3 hours and then subjected to reduction treatment for 2 hours at 800° C. under a 3% hydrogen atmosphere, to obtain a powder. The Ti was replaced with Nb to adjust the Nb doping amount (molar amount). In Example 1-1, the Nb doping amount was 2 mol %.

(Loading of Rh Nanoparticles onto Nb-Doped SrTiO₃)

The synthesized Rh nanoparticle solution and the Nb-doped SrTiO₃ powder were mixed and then stirred for 24 hours, after which the solvent was removed with an evaporator. The obtained dry powder was fired for 3 hours in air at 500° C., removing the organic material such as Rh nanoparticle-adhering PVP, and loading the Rh nanoparticles onto the Nb-doped SrTiO₃. The loading mass of Rh on the Nb-doped SrTiO₃ was adjusted to 0.5 wt %. The fired product was removed out and placed in a CIP (Cold Isostatic Pressing) bag, and vacuum-packed. The bag was pressed at 1 ton/cm² and sieved, and then impacted with a pestle to obtain pellets. The pellets were used as an exhaust gas purification catalyst sample for Example 1.

### Example 1-2

An exhaust gas purification catalyst sample for Example 1-2 was obtained in the same manner as Example 1-1, except that the doping amount of Nb in the SrTiO₃ was 5 mol %.

### Comparative Example 1-1

An exhaust gas purification catalyst sample for Comparative Example 1-1 was obtained in the same manner as Example 1-1, except that the SrTiO₃ was not doped with Nb.

### Comparative Examples 1-2 and 1-3

Exhaust gas purification catalyst samples for Comparative Examples 1-2 and 1-3 were obtained in the same manner as Example 1-1, except that the doping amounts of Nb in the SrTiO₃ were 10 mol % and 30 mol %, respectively.

### <X-Ray Crystal Diffraction Spectrometry>

Nb-doped SrTiO₃ used in each of the example samples were subjected to reduction treatment under a hydrogen atmosphere (synthesis according to “Synthesis of Nb-doped SrTiO₃” above), and then measured by X-ray crystal diffraction spectrometry. Specifically, X-ray crystal diffraction using CuKα rays was carried out using a fully automatic, multipurpose horizontal SmartLab X-ray diffractometer (9 kw), with a D/teX Ultra focusing optical system, a Cu-Kα tube, an output of 45 kV-200 mA, continuous scan mode, a sampling interval of 0.01°, a scanning rate of 1°/min and a scanning angle of 10.0 to 90.0°.

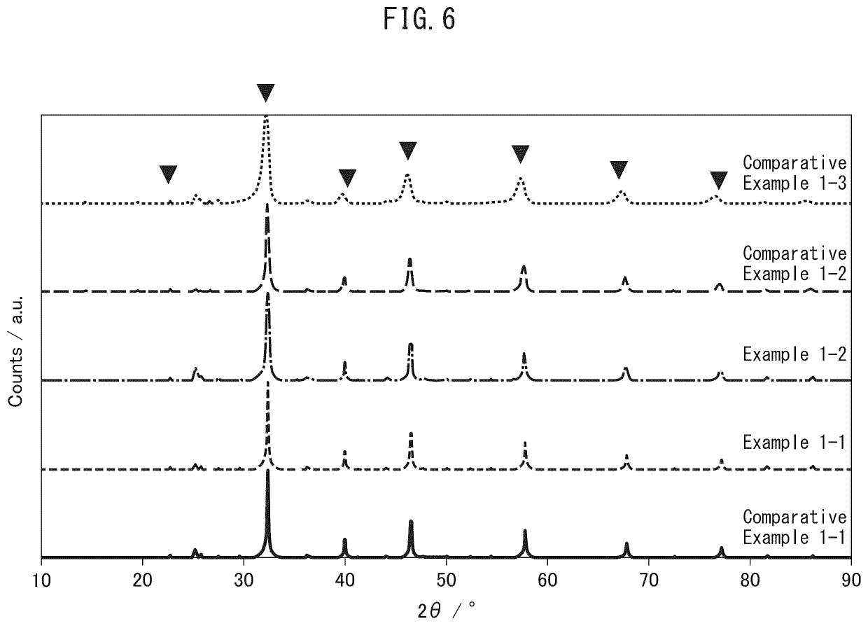

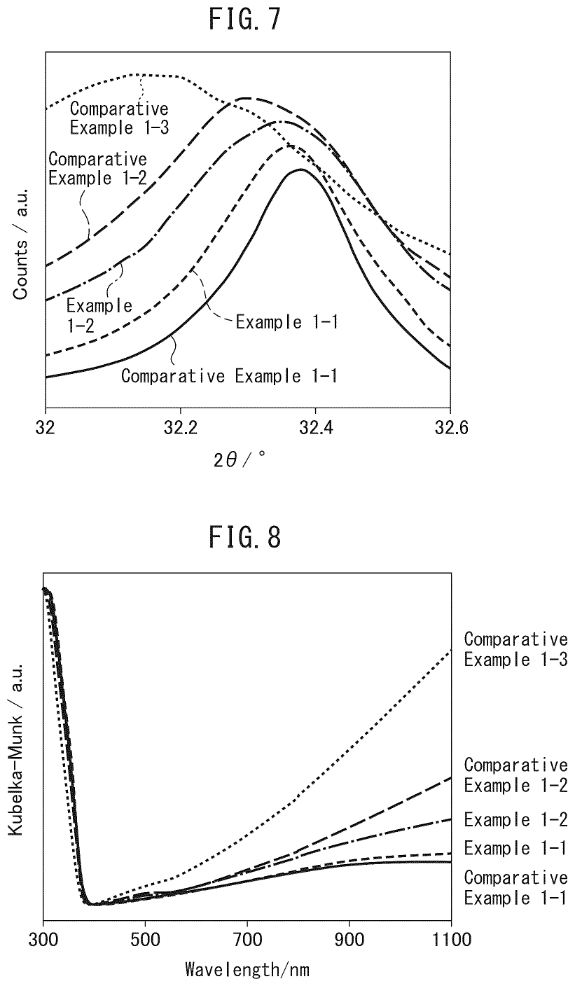

FIG. 6 and FIG. 7 show the X-ray crystal diffraction spectra for the Nb-doped SrTiO₃ used for each sample. FIG. 6 shows the range of 2θ=10.0 to 90.0° in the X-ray crystal diffraction spectrum. FIG. 7 shows the range of 2θ=32 to 32.6° in the X-ray crystal diffraction spectrum.

Based on FIG. 6, the Nb-doped SrTiO₃ used for each sample had a main peak from SrTiO₃ regardless of the Nb doping amount, indicating that it was essentially a single phase. Based on FIG. 7, increasing the Nb doping amount produced a low angle shift in the diffraction peak, with expansion of the grid due to Nb replacements at the Ti sites, indicating that Nb was dissolved as a solid solution in the SrTiO₃.

### <Measurement of Area-to-Weight Ratio>

The area-to-weight ratio of the Nb-doped SrTiO₃ used for each sample was measured by the BET method using a Tri-Star3000 by Shimadzu Corp., according to JIS K6217-2.

Table 1 shows the area-to-weight ratios (m²/g) of the Nb-doped SrTiO₃ used in each sample.

TABLE 1

| | Example | | | | |
|---|---|---|---|---|---|
| | Comp. | Example | Example | Comp. | Comp. |
| | Ex. 1-1 | 1-1 | 1-2 | Ex. 1-2 | Ex. 1-3 |
| Nb doping amount | 0 | 2 | 5 | 10 | 30 |
| (mol %) | | | | | |
| Area-to-weight | 9 | 10 | 9 | 14 | 21 |
| ratio (m²/g) | | | | | |

As shown in Table 1, with the SrTiO₃ having Nb doping amounts of 2 mol % and 5 mol % used in the samples of Examples 1-1 and 1-2, the area-to-weight ratios were 10 m²/g and 9 m²/g, respectively, which were approximately the same as the SrTiO₃ without Nb doping used in the sample of Comparative Example 1-1.

In contrast, with the SrTiO₃ having Nb doping amounts of 10 mol % and 30 mol % used in the samples of Comparative Examples 1-2 and 1-3, the area-to-weight ratios were 14 m²/g and 30 m²/g, respectively, which were larger than the area-to-weight ratio with SrTiO₃ without Nb doping used in the sample of Comparative Example 1-1.

### <Measurement of UV-Vis-NIR Diffuse Reflectance Spectra>

The Nb-doped SrTiO₃ used in each sample was measured for UV-Vis-NIR diffuse reflection (ultraviolet/visible/near-infrared diffuse reflection) and absorption spectrum using a HITACHI/U-4100 spectrophotometer by Hitachi, Ltd.

The measurement results are shown in FIG. 8.

As shown in FIG. 8, with the Nb-doped SrTiO₃ in the samples of Examples 1-1 and 1-2 and Comparative Examples 1-2 and 1-3, absorption increased in the visible-near-infrared region with increasing Nb doping amount. This was attributed to increased free electron (carrier) density of the Nb-doped SrTiO₃ by Nb doping, which resulted in increased absorption by surface plasmon resonance. This suggests that a greater amount of absorption is associated with higher carrier density.

### <X-Ray Photoelectron Spectroscopy>

The binding energy peak for the Rh_{3d} orbital was measured by X-ray photoelectron spectroscopy, for the samples of Example 1-1 and Comparative Examples 1-1 and 1-2.

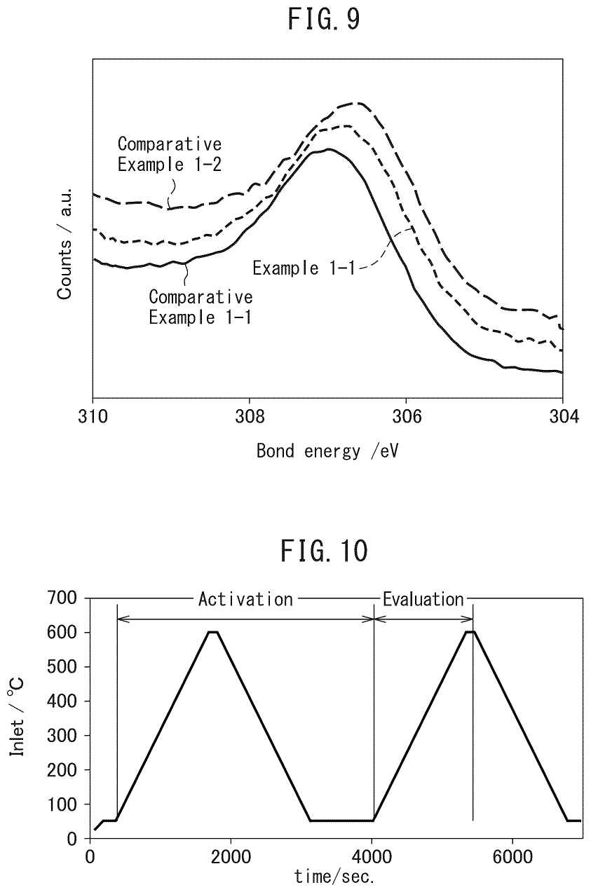

The measurement results are shown in FIG. 9.

As shown in FIG. 9, the binding energy peak for the Rh_{3d} orbital was shifted toward the low energy end in proportion to the Nb doping amount, suggesting electron enrichment of Rh. In other words, this indicated that electrons had migrated from the SrTiO₃ support doped with Nb to the Rh.

### <Evaluation of Catalytic Activity>

The temperature conditions shown in FIG. 10 and the mixed gas shown in Table 2 were used for evaluation of the catalytic activity of each sample.

For processing of the mixed gas, pellets of each sample were filled into a fixed bed circulating test apparatus and the mixed gas was circulated through at a space velocity of 200,000 h⁻¹. The temperature at which 50% NOx was purified was defined as T50, as the temperature used for comparative evaluation.

TABLE 2

| Composition | CO | CO₂ | C₃H₆ | NO | O₂ | H₂O | N₂ |
|---|---|---|---|---|---|---|---|
| Volume % | 0.65 | 10.00 | 0.10 | 0.15 | 0.70 | 3.00 | Remainder |

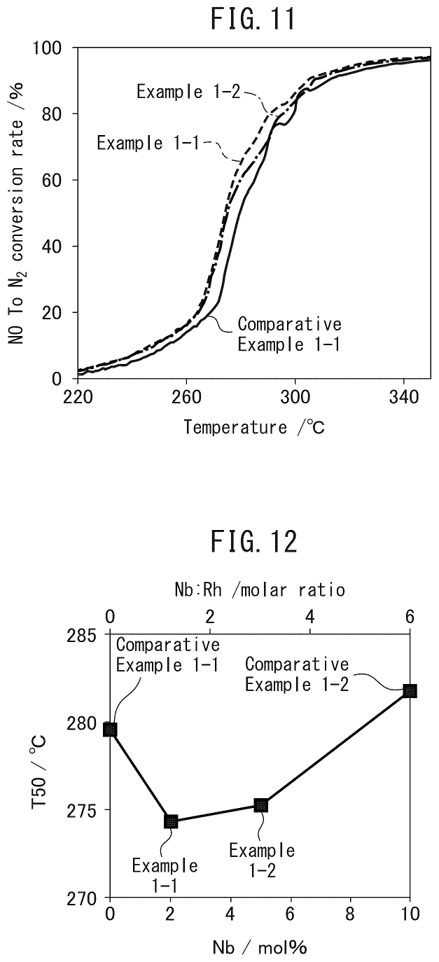

FIG. 11 shows the conversion rate from NO to N₂ for the samples of Examples 1-1 and 1-2. FIG. 12 shows the T50/° C. for each example.

As shown in FIG. 11, the samples of Examples 1-1 and 1-2 which had SrTiO₃ supports doped with Nb at 2 mol % and 5 mol %, exhibited increased NOx purification rates at low temperature, compared to Comparative Example 1-1 in which the SrTiO₃ support was not doped with Nb.

As shown in FIG. 12, the 50% purification temperature T50 for NOx was a particularly low temperature (near 275° C.) for both of the samples of Examples 1-1 and 1-2 which had SrTiO₃ supports doped with Nb at 2 mol % and 5 mol % respectively, being lower than the 50% purification temperature T50 for NOx of approximately 280° C. in Comparative Example 1-1 where Nb was not doped. In Comparative Example 1-2 where the SrTiO₃ support was doped with Nb at 10 mol %, the 50% purification temperature T50 for NOx was about 282° C., which was a higher temperature than Comparative Example 1-1 where the SrTiO₃ support was not doped with Nb.

### Examples 2-1 to 2-4 and Comparative Examples 2-1 to 2-3

### Example 2-1

### (Synthesis of Rh Nanoparticles)

Rh nanoparticles were obtained in the same manner as Example 1-1.

### (Synthesis of Nb-Doped ZrO₂)

Nb-doped ZrO₂ was synthesized by a citric acid method. Specifically, Nb-doped ZrO₂ was synthesized in the following manner. Specifically, distilled water, citric acid, zirconium oxynitrate and niobium ammonium oxalate-decahydrate were mixed in a beaker, and the mixture was heated and stirred and evaporated to dryness. The mixture was then further dried overnight in a constant temperature furnace at 120° C. The dried product was fired in air at 800° C. for 3 hours and then subjected to reduction treatment for 2 hours at 800° C. under a 3% hydrogen atmosphere, to obtain a powder. The Zr was replaced with Nb to adjust the Nb doping amount (molar amount). The doping amount of Nb was 5 mol % with respect to the ZrO₂.

(Loading of Rh Nanoparticles onto Nb-Doped ZrO₂)

The Rh nanoparticle solution (SCH) and Nb-doped ZrO₂ powder were mixed, heated and stirred, and evaporated to dryness. The mixture was then further dried overnight in a constant temperature furnace at 120° C. The obtained dry powder was fired for 3 hours in air at 500° C., removing the organic material such as Rh nanoparticle-adhering PVP, and loading the Rh nanoparticles onto the Nb-doped ZrO₂. The loading mass of Rh on the Nb-doped ZrO₂ was adjusted to 0.5 wt %. The fired product was removed out and placed in a CIP (Cold Isostatic Pressing) bag, and vacuum-packed. The bag was pressed at 1 ton/cm² and sieved, and then impacted with a pestle to obtain pellets. The pellets were used as the exhaust gas purification catalyst sample.

### Examples 2-2 to 2-4 and Comparative Examples 2-2 and 2-3

Exhaust gas purification catalyst samples were obtained for Examples 2-2 to 2-4 and Comparative Examples 2-2 and 2-3 in the same manner as Example 2-1, except that the Nb doping amounts in the ZrO₂ were 10 mol % (Example 2-2), 15 mol % (Example 2-3), 20 mol % (Example 2-4), 2 mol % (Comparative Example 2-2) and 30 mol % (Comparative Example 2-2).

### Comparative Example 2-1

An exhaust gas purification catalyst sample for Comparative Example 2-1 was obtained in the same manner as Example 2-1, except that the ZrO₂ was not doped with Nb.

### <X-Ray Crystal Diffraction Spectrometry>

The Nb-doped ZrO₂ used in each of the samples was measured by X-ray crystal diffraction spectrometry, by the same method as Example 1-1. The Nb-doped ZrO₂ was used immediately after the synthesis described above under “Synthesis of Nb-doped ZrO₂”.

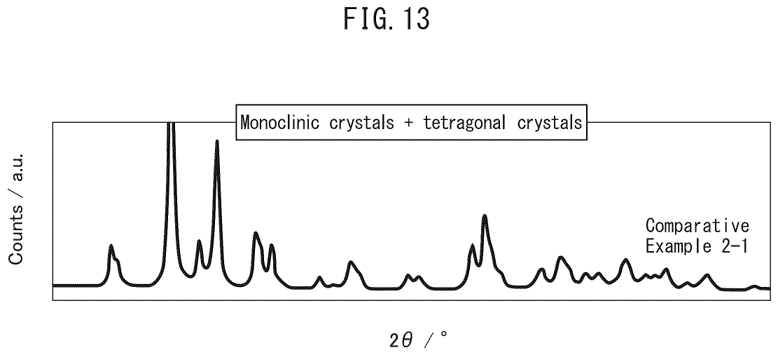

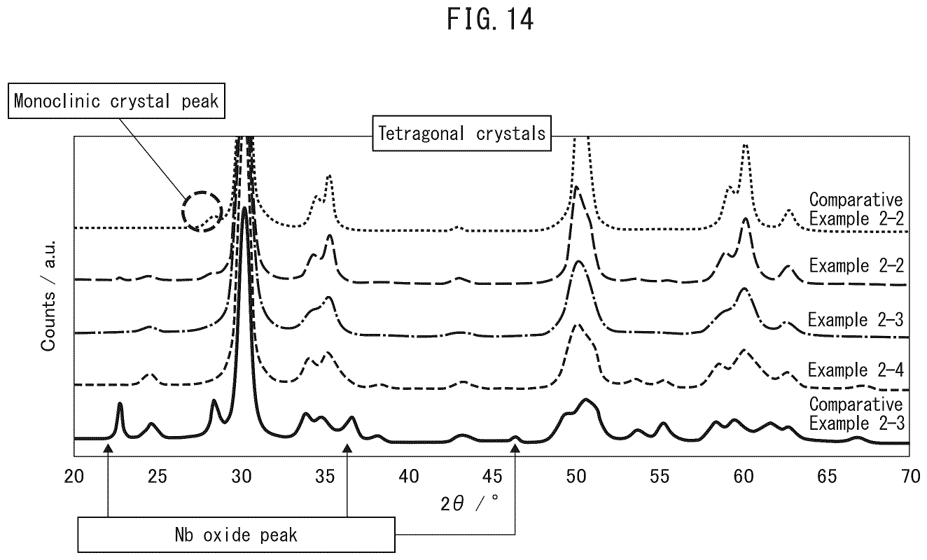

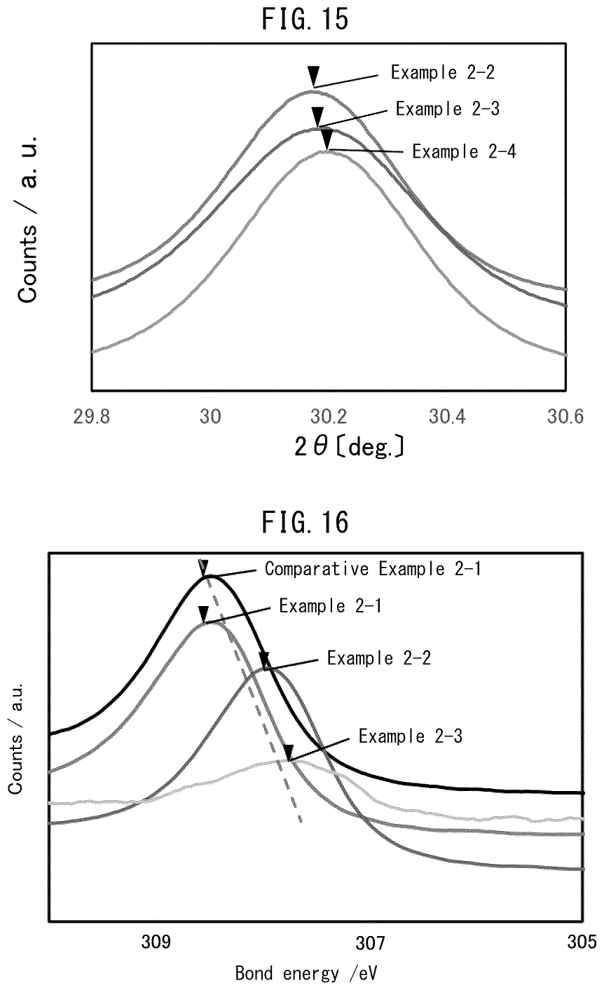

FIGS. 13 to 15 show the X-ray crystal diffraction spectra for the Nb-doped ZrO₂ used for each sample. FIGS. 13 and 14 show the range of 2θ=20.0 to 70.0° in the X-ray crystal diffraction spectra. FIG. 15 shows the range of 2θ=29.8 to 30.6° in the X-ray crystal diffraction spectra.

FIG. 13 shows the X-ray crystal diffraction spectrum for the ZrO₂ used in the sample of Comparative Example 2-1. The main phase of the non-Nb-doped ZrO₂ was monoclinic crystalline. As shown in FIG. 14, doping ZrO₂ with even a small amount (2%) of Nb produces tetragonal crystals as the main phase, with a main peak appearing at near 30°. In addition, as shown in FIG. 15, the Nb-doped ZrO₂ used in the samples of Examples 2-2 to 2-4 showed a high-angle shift in the diffraction peak with increasing Nb doping amount and contraction of the lattice by substitution of Nb at the Zr sites can be seen, indicating that Nb was dissolved as a solid solution in ZrO₂.

### <X-Ray Photoelectron Spectroscopy>

The binding energy peak for the Rh_{3d} orbital was measured by X-ray photoelectron spectroscopy, for the samples of Examples 2-1 to 2-3 and Comparative Example 2-1.

The measurement results are shown in FIG. 16.

As shown in FIG. 16, the binding energy peak for the Rh_{3d} orbital was shifted toward the low energy end in proportion to the Nb doping amount, suggesting electron enrichment of Rh. In other words, this indicated that electrons had migrated from the Nb-doped ZrO₂ support to the Rh.

### <Evaluation of Catalytic Activity>

The temperature conditions shown in FIG. 10 and the mixed gas shown in Table 2 were used for evaluation of the catalytic activity of each sample, in the same manner as Example 1-1.

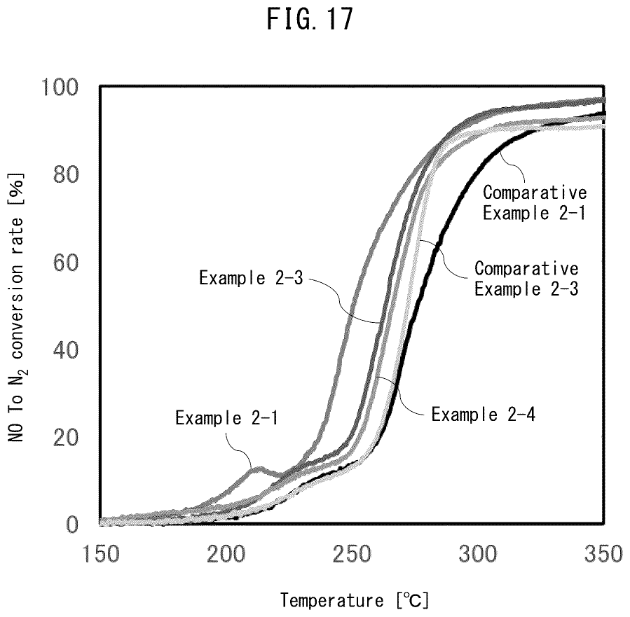

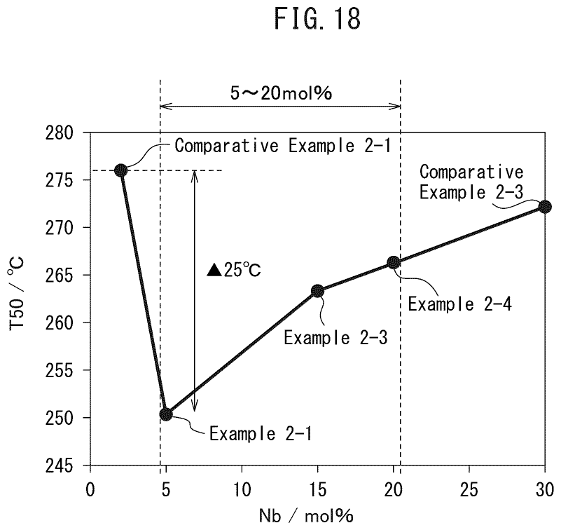

FIG. 17 shows the conversion rates from NO to N₂ for the samples of Examples 2-1, 2-3 and 2-4 and Comparative Examples 2-1 and 2-3. FIG. 18 shows the T50/° C. for each example.

As shown in FIG. 16, the samples of Examples 2-1, 2-3 and 2-4, which had ZrO₂ supports doped with Nb at 5 to 20 mol %, exhibited increased NOx purification rates at low temperature, compared to Comparative Example 1-1 where the ZrO₂ support was not doped with Nb and Comparative Example 2-3 where the ZrO₂ support was doped with 2 mol % Nb.

As shown in FIG. 17, the 50% purification temperature T50 for NOx was a particularly low temperature (near 250° C. to 272° C.) for both of the samples of Examples 2-1, 2-3 and 2-4 which had ZrO₂ supports doped with Nb at 5 to 20 mol %, being lower than the 50% purification temperature T50 for NOx of about 276° C. in Comparative Example 2-3 where Nb was doped at 2 mol %. In particular, the T50 for the sample of Example 2-1 was more than 25° C. lower than the T50 for the sample of Comparative Example 2-3.

### Examples 3-1 to 3-4 and Comparative Examples 3-1 and 3-2

### Example 3-1

### (Synthesis of Rh Nanoparticles)

Rh nanoparticles were obtained in the same manner as Example 1-1.

(Synthesis of Ti-Doped Al₂O₃)

Ti-doped Al₂O₃ was synthesized by complex polymerization. Specifically, synthesis was carried out in the following manner. After mixing 40.4 wt % of distilled water, aluminum nitrate-nonahydrate, lanthanum(III) nitrate-hexahydrate and Ti(IV) dihydroxy bis(ammonium lactate) in a beaker, citric acid and ethylene glycol were added and the mixture was heated and stirred and evaporated to dryness. The mixture was then further dried overnight in a constant temperature furnace at 120° C. The dried product was fired in air at 900° C. for 3 hours and then subjected to reduction treatment for 2 hours at 800° C. under a 3% hydrogen atmosphere, to obtain a powder. The Al was replaced with Ti to adjust the Ti doping amount (molar amount). The doping amount of Ti was 1 mol % with respect to the Al₂O₃.

(Loading of Rh Nanoparticles onto Ti-Doped Al₂O₃)

The synthesized Rh nanoparticle solution and the Ti-doped Al₂O₃ powder were mixed and then stirred for 24 hours, after which the solvent was removed with an evaporator. The obtained dry powder was fired for 3 hours in air at 500° C., removing the organic material such as Rh nanoparticle-adhering PVP, and loading the Rh nanoparticles onto the Ti-doped Al₂O₃. The loading mass of Rh on the Ti-doped Al₂O₃ was adjusted to 0.5 wt %. The fired product was removed out and placed in a CIP (Cold Isostatic Pressing) bag, and vacuum-packed. The bag was pressed at 1 ton/cm² and sieved, and then impacted with a pestle to obtain pellets. The pellets were used as the exhaust gas purification catalyst sample.

### Examples 3-2 to 3-4 and Comparative Example 3-2

Exhaust gas purification catalyst samples were obtained for Examples 3-2 to 3-4 and Comparative Example 3-2 in the same manner as Example 3-1, except that the Ti doping amounts in the Al₂O₃ were 3 mol % (Example 3-2), 5 mol % (Example 3-3), 7 mol % (Example 3-4) and 10 mol % (Comparative Example 3-2).

### Comparative Example 3-1

An exhaust gas purification catalyst sample for Comparative Example 3-1 was obtained in the same manner as Example 3-1, except that the Al₂O₃ was not doped with Ti.

### <X-Ray Crystal Diffraction Spectrometry>

The Ti-doped Al₂O₃ used in each of the samples was measured by X-ray crystal diffraction spectrometry, by the same method as Example 1-1. The Ti-doped Al₂O₃ was used immediately after the synthesis described above under “Synthesis of Ti-doped Al₂O₃”.

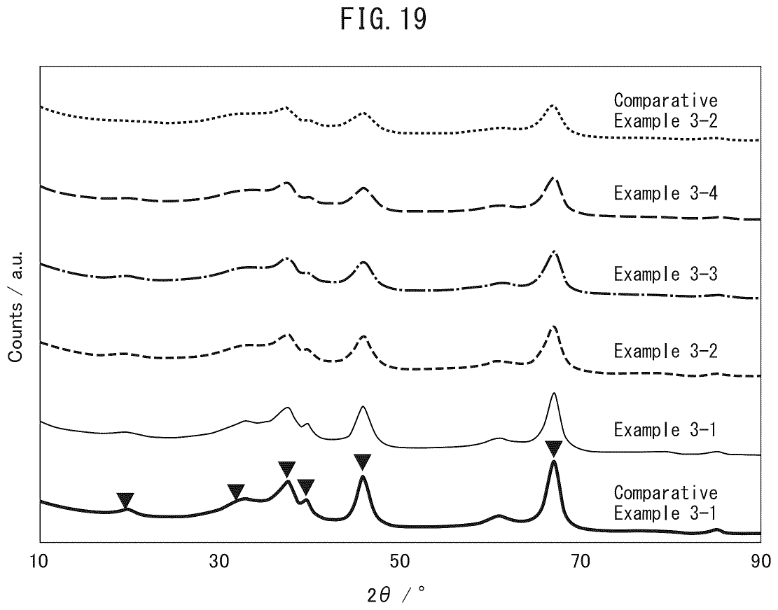

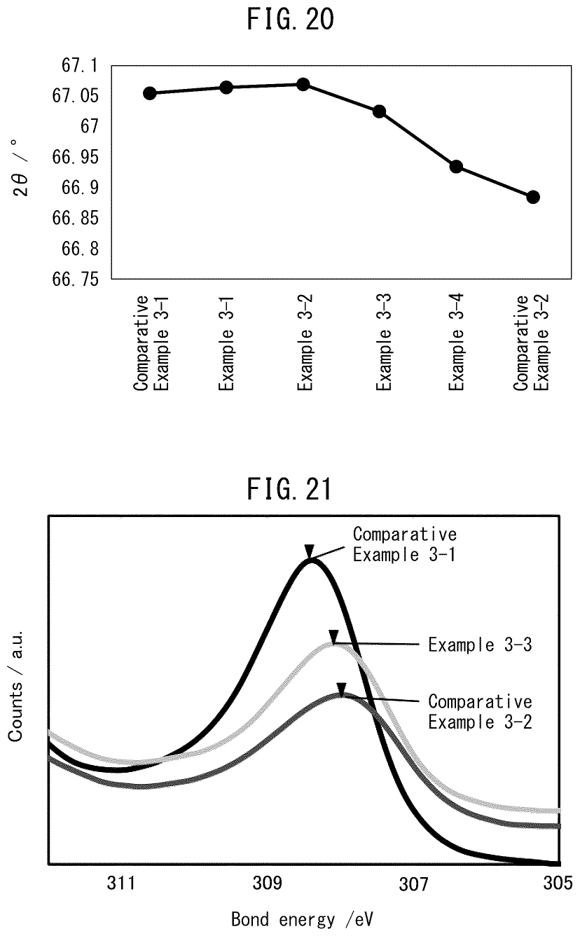

FIG. 19 shows the X-ray crystal diffraction spectra for the Ti-doped Al₂O₃ used for each sample. FIG. 19 shows the range of 2θ=10.0 to 90.0° in the X-ray crystal diffraction spectrum. FIG. 20 is a graph comparing the main peak locations in X-ray diffraction spectra for the samples of Examples 3-1 to 3-4 and Comparative Examples 3-1 and 3-2.

Based on FIG. 19, the synthesized Ti-doped Al₂O₃ had a main peak for γ-Al₂O₃ regardless of the Ti doping amount, indicating that it was essentially a single phase. Based on FIG. 20 (right), increasing the Ti doping amount produced a low angle shift in the diffraction peak, with expansion of the grid due to Ti replacements at the Al sites, indicating that Ti was dissolved as a solid solution in the Al₂O₃.

### <X-Ray Photoelectron Spectroscopy>

The binding energy peak for the Rh_{3d} orbital was measured by X-ray photoelectron spectroscopy, for the samples of Example 3-3 and Comparative Examples 3-1 and 3-2.

The measurement results are shown in FIG. 21.

As shown in FIG. 21, the binding energy peak for Rh_{3d} was shifted toward the low energy end in proportion to the Ti doping amount, suggesting electron enrichment of Rh. In other words, this indicated that electrons had migrated from the Ti-doped Al₂O₃ support to the Rh.

### <Evaluation of Catalytic Activity>

The temperature conditions shown in FIG. 10 and the mixed gas shown in Table 2 were used for evaluation of the catalytic activity of each sample, in the same manner as Example 1-1.

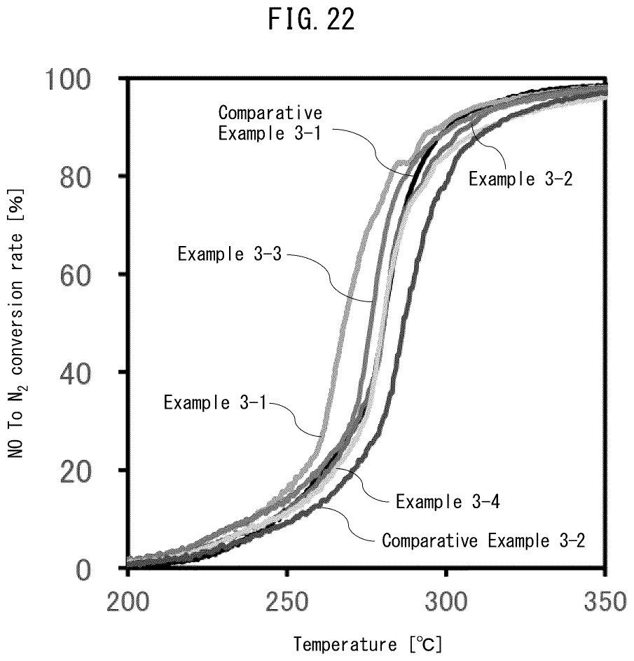

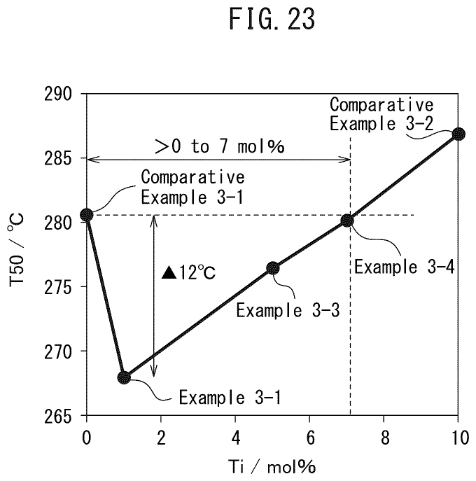

FIG. 22 shows the conversion rate from NO to N₂ for each of the samples of the Examples. FIG. 23 shows the T50/° C. for each Example.

As shown in FIG. 22, the samples of Examples 3-1, 3-2, 3-3 and 3-4, which had Al₂O₃ supports doped with Ti at 1 to 7 mol %, exhibited increased NOx purification rates at low temperature, compared to Comparative Example 3-1 where the Al₂O₃ support was not doped with Ti and Comparative Example 3-2 where the Al₂O₃ support was doped with 10 mol % Ti.

Moreover, as shown in FIG. 23, the 50% purification temperature T50 for NOx was a particularly low temperature (near 267° C. to 280° C.) for the samples of Examples 3-1, 3-2, 3-3 and 3-4 which had Al₂O₃ supports doped with Ti at 1 to 7 mol %, being lower than the 50% purification temperature T50 for NOx of about 281° C. in Comparative Example 3-1 where Ti was not doped, and Comparative Example 3-2 where Ti was doped at 10 mol %. In particular, the T50 for the sample of Example 3-1 was more than 12° C. lower than the T50 for the sample of Comparative Example 3-1.

### REFERENCE SIGNS LIST

1 Exhaust gas purification catalyst
2 SrTiO₃ support
3 Rh particles
4 Exhaust gas
5 Purified exhaust gas

1. An exhaust gas purification catalyst
comprising a metal oxide support and Rh particles supported on the metal oxide support,
wherein the metal oxide support is doped with a cation having a higher oxidation number than the cation of the metal oxide support.

2. The exhaust gas purification catalyst according to claim 1, wherein the metal oxide support is a SrTiO₃ support doped with greater than 0 mol % and 8 mol % or lower Nb, a ZrO₂ support doped with 5 mol % to 20 mol % Nb, or an Al₂O₃ support doped with greater than 0 mol % and 7 mol % or lower Ti.

3. The exhaust gas purification catalyst according to claim 1, wherein the metal oxide support is a SrTiO₃ support doped with greater than 0 mol % and 8 mol % or lower Nb, and has a peak from SrTiO₃ of the SrTiO₃ support in the range of 32.20°<2θ<32.38°, in the X-ray diffraction spectrum by X-ray crystal diffraction using CuKα rays.

4. The exhaust gas purification catalyst according to claim 1, wherein the metal oxide support is a SrTiO₃ support doped with greater than 0 mol % and 8 mol % or lower Nb, and the near-infrared diffuse reflectance spectrum of the SrTiO₃ support at a wavelength of 900 nm or greater is larger than the near-infrared diffuse reflectance spectrum of a non-Nb-doped SrTiO₃ support at a wavelength of 900 nm or greater.

5. The exhaust gas purification catalyst according to claim 1, wherein the metal oxide support is a SrTiO₃ support doped with greater than 0 mol % and 8 mol % or lower Nb, and the peak for the bond energy of the 3d orbital of Rh is in the range of 306 to 307 eV after hydrogen reduction in a 1% H₂/N₂ atmosphere with a heating temperature of 400° C. and a heating time of 1 hour.

6. The exhaust gas purification catalyst according to claim 1, which is a three-way catalyst.

7. An exhaust gas purification method which includes contacting exhaust gas with an exhaust gas purification catalyst according to claim 1.

8. A method for producing an exhaust gas purification catalyst according to claim 1, wherein the method includes:
providing the metal oxide support, and
loading Rh particles onto the metal oxide support.

9. The method according to claim 8, wherein the metal oxide support is a SrTiO₃ support doped with greater than 0 mol % and 8 mol % or lower Nb.

10. The method according to claim 8, wherein the metal oxide support is a ZrO₂ support doped with 5 mol % to 20 mol % Nb.

11. The method according to claim 8, wherein the metal oxide support is an Al₂O₃ support doped with greater than 0 mol % and 7 mol % or lower Ti.

12. The method according to claim 9, wherein provision of the SrTiO₃ support includes synthesizing the SrTiO₃ support by a sol-gel method.

13. The method according to claim 10, wherein provision of the ZrO₂ support includes synthesizing the ZrO₂ support by a citric acid method.

14. The method according to claim 11, wherein provision of the Al₂O₃ support includes synthesizing the Al₂O₃ support by complex polymerization.
